(19) United States
(12) Patent Application Publication
(10) Pub. No.: US 2010/0153262 A1
(43) Pub. Date: Jun. 17, 2010

(54) SYSTEM AND METHOD FOR ADMINISTERING INSURANCE AND LOAN ACCOUNTS

(75) Inventors: Richard J. Wirth, West Hartford, CT (US); Keith E. Golembiewski, Suffield, CT (US)

Correspondence Address: Howard IP Law Group, P.O. Box 226, Fort Washington, PA, 19034, US

(73) Assignee: HARTFORD FIRE INSURANCE COMPANY, Hartford, CT (US)

(21) Appl. No.: 12/334,073

(22) Filed: Dec. 12, 2008

(51) Int. Cl. G06Q 40/00

(52) U.S. Cl. 705/39; 705/35; 705/45

(57) ABSTRACT

A computer system for administering an insurance policy and a loan made to the insured, includes a processor and a memory in communication with the processor. The processor is adapted to: access from the memory storage device data relating to the insurance policy and the loan; determine, based on the accessed data, an amount of a withdrawal from the insurance policy and an amount of a payment on the loan; determine, by deducting the amount of the payment on the loan from the amount of the withdrawal, an amount of a payment, if any, to the insured; and provide output signals to a payment system to implement the payment on the loan and the payment, if any, to the insured.

### FIELD OF INVENTION

The present invention relates to computer systems, and particularly to computer systems for calculating features of financial products.

### BACKGROUND

Many individuals and families have substantial interests in assets that do not produce income, and a need for additional income. A common example is a retired individual who has paid off a home mortgage, but has private pension, savings, government pension (such as Social Security in the United States) resources that do not provide an adequate or desirable level of income. As home prices in many areas have increased substantially over a long period of time, a retired individual or couple who have owned a home may have substantial equity in the home.

In the prior art, a financial product known as a reverse mortgage has provided income based on the equity in the home. In a reverse mortgage, an older homeowner, generally 62 or older, grants a mortgage on the home to a lender. The consideration received by the homeowner varies depending on the type of reverse mortgage. In a tenure reverse mortgage, the homeowner receives a monthly stream of income for as long as the homeowner, or for as long as either of a couple, lives in the home. In a term reverse mortgage, the homeowner receives a monthly stream of income for a predetermined period of time. In a line of credit reverse mortgage, the homeowner receives payments in amounts and at times as requested by the homeowner, up to the amount of the line of credit. There are also variations which include features of both term and line of credit reverse mortgages, and tenure and line of credit reverse mortgages. The mortgage secures repayment of the principal and interest accrued on the principal. The transaction is structured, considering the payments to the homeowner, the rate of interest, the anticipated duration of the loan and the rate of home price appreciation, so that the loan amount is not expected to exceed the value of the home at any time during the life of the loan. Fees associated with initiation of the reverse mortgage are often paid from loan proceeds; interest on the principal amount of the loan attributable to fees increases the cost of the loan. Repayment is generally due in a lump sum when the homeowner dies or ceases to live in the home. A reverse mortgage is generally a non-recourse loan. In many cases, the homeowner or the homeowner's estate will sell the home in order to raise cash to repay the loan. If the sale fails to close sufficiently promptly, the loan may go into default. If the homeowner or estate fails to repay the loan from other sources, the lender may foreclose on the home. Since reverse mortgages can provide only a limited amount of income, they are available only to individuals who are relatively elderly and would, by actuarial statistics, have a limited expected lifespan. Reverse mortgages have been criticized as being excessively expensive to procure and providing relatively limited liquidity to the borrower.

A home equity loan is another type of loan in which older homeowners may convert home equity into immediately available cash. A home equity lender obtains a first or secondary mortgage lien against the borrower's primary residence as collateral. Home equity loans may be revolving, in that the borrower may repay and then later re-borrow against their home equity. Interest only is payable during the draw down phase. The then remaining outstanding principal and interest is repaid either as a balloon payment at the end of the draw down phase or may be repaid on an amortization schedule over a fixed period commencing at the end of the drawn down phase. The term of the home equity loan may be fixed or variable. Older homeowners in need of cash for living expenses may not meet income qualifications for many home equity lenders.

A conventional or forward mortgage is another manner for a borrower to convert equity in a home into cash for current expenses. The lender obtains a mortgage lien against the home as collateral. Conventional loans secured by mortgages may be fully amortized, in that principal and interest are repaid in accordance with a predetermined schedule, with level periodic, e.g., monthly, payments. Conventional loans may alternatively provide for payment of interest during the term, with the repayment of principal in a single payment, or a balloon payment, due at the end of the loan term.

### SUMMARY OF THE INVENTION

In one embodiment, a computer system for administering a variable annuity account, having a guaranteed minimum withdrawal rider, with an annuitant, the annuitant also being a mortgagor of a home mortgage, the mortgage securing a loan having a level amortization repayment schedule, includes a processor and a memory storage device in communication with the processor. The processor is adapted to access from the memory storage device data indicative of whether the annuitant is living, and, if the annuitant is living, access from the memory storage device data relating to the variable annuity account; access from the memory storage device data relating to the loan; determine, based on the data relating to the variable annuity account, an amount of a withdrawal from the variable annuity account; determine, based on the data relating to the loan, an amount of a payment on the loan, and store the determined amount of the payment on the loan; determine, by deducting the amount of the payment on the loan to the amount of the withdrawal, an amount of a payment to the annuitant, and store the determined amount of the payment on the loan; provide an output signal to a payment system to implement the payment on the loan; provide an output signal to the payment system to implement the payment to the annuitant. The processor may further be adapted, if the annuitant is not living, to access from the memory storage device data relating to the variable annuity account; access from the memory storage device data relating to the loan; determine, based on the data relating to the variable annuity account, a death benefit amount and beneficiary; determine, based on the data relating to the loan, a payoff amount; determine, by deducting the payoff amount from the death benefit amount, an amount payable to the beneficiary; provide an output signal to the payment system to implement a loan payment in the amount of the payoff amount, and provide an output signal to the payment system to implement a payment to the beneficiary in the amount payable to the beneficiary.

In an embodiment, a computer system for administering an insurance policy, the insured under policy also being a borrower on a loan secured by a lien on an asset, includes a processor and a memory storage device in communication with the processor. The processor is adapted to access from the memory storage device data relating to the insurance policy; access from the memory storage device data relating to the loan; determine, based on the data relating to the insurance policy, an amount of a withdrawal from the insurance policy, and store the amount of the withdrawal; determine, based on the data relating to the loan, an amount of a payment on the loan, and store the determined amount of the payment on the loan; determine, by deducting the amount of the payment on the loan from the amount of the withdrawal, an amount, if any, of a payment to the insured, and store the determined amount of the payment on the loan; provide an output signal to a payment system to implement the payment on the loan; and, if there is a payment to the insured, provide an output signal to the payment system to implement the payment to the insured.

In an embodiment, a computer-implemented method for administering an insurance policy, the insured under the policy also being a borrower on a loan secured by a lien on an asset, includes accessing by a processor from a memory storage device in communication with the processor data relating to the insurance policy; accessing by the processor from the memory storage device data relating to the insurance policy;; accessing from the memory storage device data relating to the loan; determining, based on the data relating to the insurance policy, an amount of a withdrawal from the insurance policy, and storing the amount of the withdrawal; determining, based on the data relating to the loan, an amount of a payment on the loan, and storing the determined amount of the payment on the loan; determining, by deducting the amount of the payment on the loan from the amount of the withdrawal, an amount, if any, of a payment to the insured, and storing the determined amount of the payment on the loan; providing an output signal to a payment system to implement the payment on the loan; and, if there is a payment to the insured, providing an output signal to the payment system to implement the payment to the insured.

In an embodiment, a computer-readable medium has instructions thereon which, when executed by a processor, cause the processor to perform, in connection with administration of an insurance policy in which the insured under the policy is a borrower on a loan secured by an asset; access from a memory storage device in communication with the processor, data relating to the insurance policy; access from the memory storage device data relating to the loan; determine, based on the data relating to the insurance policy, an amount of a withdrawal from the insurance policy; determine, based on the data relating to the loan, an amount of a payment on the loan, and store the determined amount of the payment on the loan; determine, by deducting the amount of the payment on the loan to the amount of the withdrawal, an amount, if any, of a payment to the insured, and store the determined amount of the payment to the insured; provide an output signal to a payment system to implement the payment on the loan; and, if there is a payment to the insured, provide an output signal to the payment system to implement the payment to the insured.

### BRIEF DESCRIPTION OF DRAWINGS

FIG. 1 is a schematic diagram of an exemplary computer system for implementation of a method and system of the invention.

FIG. 2 is a schematic diagram of an exemplary network for implementation of a method and system of the invention.

FIG. 3 is a process flow diagram illustrating a method for administering insurance and loan accounts and implemented by the computer system of FIG. 1.

FIG. 4 is a schematic diagram illustrating implementation of a method for administration of annuities and loan accounts according to an embodiment.

FIG. 5 is a schematic diagram of a system for providing information concerning annuities and loan accounts.

FIG. 6 is a table illustrating an example of an implementation of a method and system for administering variable annuity accounts and loan accounts.

FIG. 7 is a table illustrating an example of an implementation of a method and system for administering single premium immediate annuity accounts and loan accounts.

FIG. 8 is a process flow diagram of a method of determining an updated benefit base for a minimum withdrawal benefit guarantee in an embodiment.

### DETAILED DESCRIPTION

It is to be understood that the figures and descriptions of embodiments of the present invention have been simplified to illustrate elements that are relevant for a clear understanding of the present invention, while eliminating, for the purpose of clarity, many other elements found in typical computer systems and methods for administration of insurance accounts and insurance products such as annuities, and for administration of loan accounts. Those of ordinary skill in the art may recognize that other elements and/or steps are desirable and/or required in implementing embodiments of the present invention. However, because such elements and steps are well known in the art, and because they do not facilitate a better understanding of the present invention, a discussion of such elements and steps is not provided herein.

A challenge recognized by the inventors is that obtaining immediate income from valuable assets, while preserving resources for repayment of a loan secured by the valuable assets, is desirable.

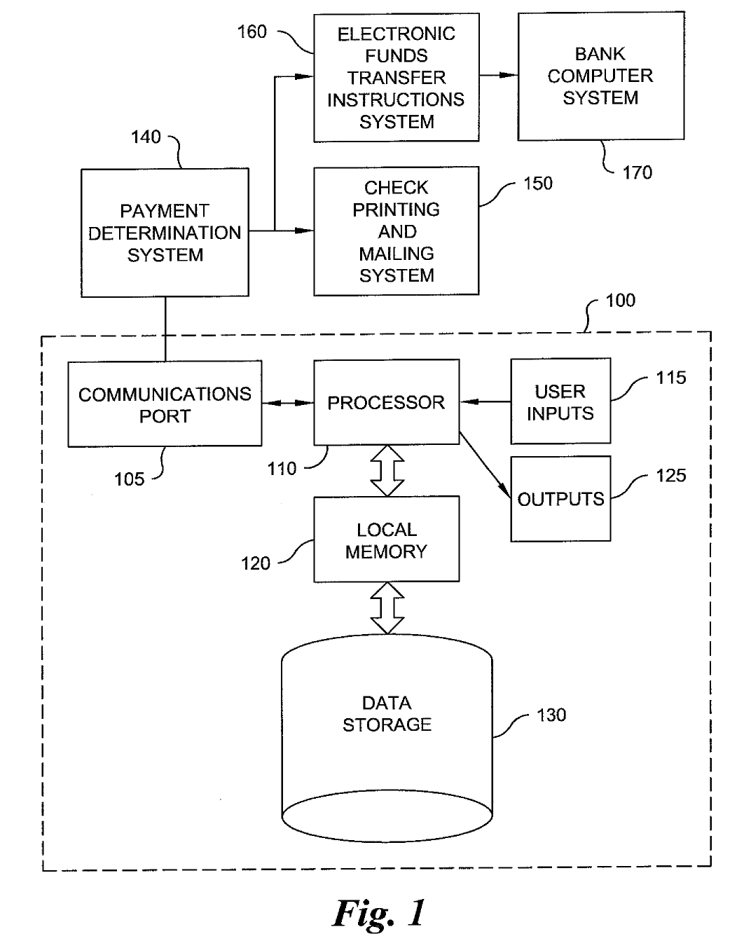

Referring to FIG. 1, an exemplary computer system 100 for use in an implementation of the invention will now be described. In computer system 100, processor 110 executes instructions contained in programs stored on stored media. Processor 110 communicates, such as through suitable buses and other data channels, with communications port 105 and local memory 120, receives data from user inputs 115, and provides data to outputs 125. Local memory 120 is configured to exchange data with processor 110, and may store programs containing processor-executable instructions, and values of variables for use by such programs. Data storage 130 may include a wide variety of data acquired and processed in accordance with embodiments of the invention. Data storage 130 may include payment method data 132, by way of example. User input may be provided at inputs 115, which may include keyboards, pointing devices such as mice, and touchscreens. In an embodiment, inputs 115 may include user interfaces, including workstations having keyboards, touchscreens, pointing devices such as mice, or other user input devices, connected via networked communications to processor 110. Outputs 125 may include displays and printers. Communications port 105 may communicate with remote sources of information, and with systems for implementing instructions output by processor 110. Communication may be by one or more of suitable communication methods, including over wired or wireless local area networks and wide area networks, and over communications between networks, including over the Internet. Any suitable data and communication protocols may be employed.

Communications port 105 may communicate with payment determination system 140. Payment determination system 140 may include one or more computer systems, including processors, memory devices, user inputs, outputs, software executed by the processors, and other conventional components. Payment determination system 140 may be adapted to receive an output signal via communications port 105, which output signal includes data indicative of payment information, such as amounts payable to an annuitant and a lender, a date payable, information identifying an annuitant, information identifying a lender or lender's agent, such as a mortgage services provider, and payment methods. Payment determination system 140 may further be adapted to determine a payor account and a payment method. The payor account may be an account with a selected bank; by way of example, payment determination system 140 may include a look-up table mapping annuitant and lender information, such as geographic information, to a particular bank and account. Payment determination system 140 may also include stored in memory and accessible by a processor information indicating whether a particular insured or other designee or a particular lender is to be paid by paper check, by electronic funds transfer, or by another payment method. A processor of payment determination system 140 may cause to be stored in memory of the payment determination system the determined payor account information and the determined payment method. The processor of payment determination system 140 may cause a digital signal to be output indicative of the stored payor account information, the stored payment method, amount information and payee information. Depending on the payment method information, payment determination system 140 may direct a signal to one of a number of potential recipients. The potential recipients may include payment fulfillment systems, such as check printing and mailing system 150 and electronic funds transfer instructions system 160. The payment fulfillment systems may be for receiving the digital signal from the payment determination system 140 and for fulfillment of payment in accordance with the information conveyed by the digital signal from the processor of the payment determination system 140.

In an embodiment, the payment method may be by check; given that payment method, the output digital signal from payment determination system 140 may be received by check printing and mailing system 150. Check printing and mailing system 150 may include one or more computer systems, including processors, memory devices, user inputs, outputs, software executed by the processors, and other conventional components. The outputs include in particular one or more printers, and may include other devices useful in printing and mailing paper checks, such as devices for feeding paper, separating printed checks, inserting printed checks into envelopes, sealing envelopes, and applying postage to envelopes as appropriate. Check printing and mailing system 150 may print a check drawn on a payor account in an amount and to a payee as determined by the information conveyed by the digital signal from the processor of payment determination system 140. The printed check is then mailed to the payee, which may be the annuitant or a lender. The annuitant or lender deposits the check in the recipient's bank account, causing funds to be credited to the recipient's bank account, and causing the funds to be withdrawn from the designated payor bank account from which the payment is made.

In an embodiment, the output digital signal from payment determination system 140 may be received by electronic funds transfer instructions system 160. For example, this may be the case if the payment method is by electronic funds transfer to the payee's designated account. Electronic funds transfer instructions system 160 may include one or more computer systems, including processors, memory devices, user inputs, outputs, software executed by the processors, and other conventional components. Electronic funds transfer instructions system 160 includes a processor adapted to provide an output signal indicative of an instruction to a bank determined by the payor account information to provide an electronic funds transfer from the payor account to a payee account in an amount as previously determined, such as by processor 110. The amount is the amount determined by the information conveyed by the digital signal from payment determination system 140.

The output signal from electronic funds transfer instructions system 160 may be provided to a bank computer system 170, which carries out an electronic funds transfer, debiting the designated account, and resulting in a credit to a designated payee account.

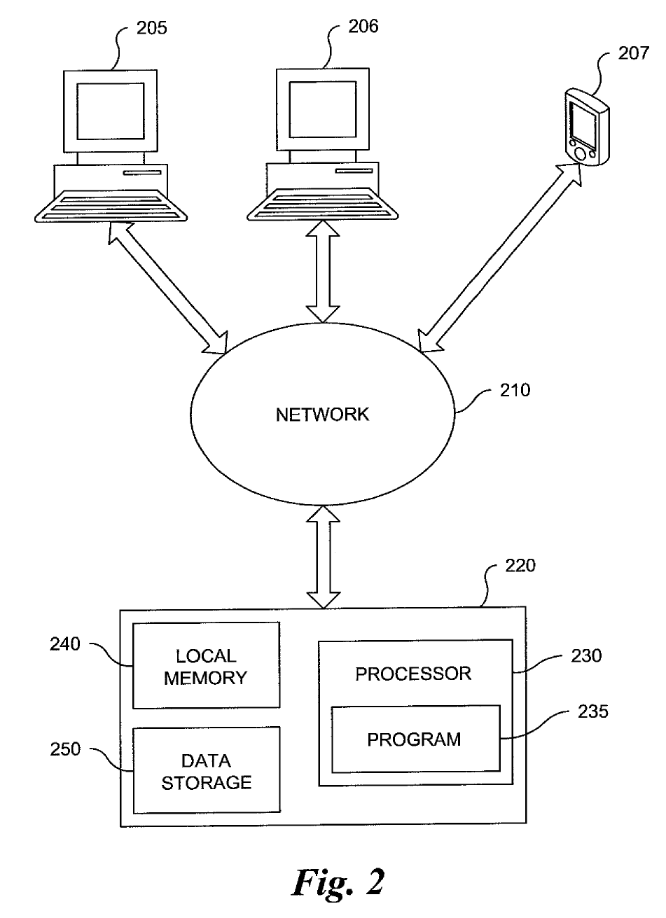

Referring now to FIG. 2, a schematic diagram of a client server arrangement for implementation of a method and system in accordance with an embodiment of the invention is presented. In the arrangement of FIG. 2, client devices 205, 206, 207 may be connected via network 210 to server 220. In an implementation, client devices 205, 206, 207 may be personal computers running an operating system such as Windows XP, Windows Vista, or Apple Tiger, thin client devices, portable devices such as personal digital assistants (running the Palm OS, by way of example), cell phones, or other devices. Client devices may be operated variously by individual prospective annuitants, insurance brokers or other financial advisors, or by personnel of an insurance service provider. Network 210 may be or include the Internet, a corporate intranet, wireless and wired communications channels, and other network features. Server 220 may include processor 230 having local memory 240 and data storage 250. Program 235 runs on processor 230. Program 235 may initiate sessions with one more of client devices 205, 206, 207. Program 235 may cause server 220 to serve for display on client devices 205, 206, 207, prompts to the user for information regarding real property available to be mortgaged, other assets available to be pledged, other sources of retirement income, possible needs of beneficiaries, desired income and desired asset value goals, and/or possible expense items, and based on information received and various algorithms related to annuity contracts and loans secured by mortgages and other secured lending, provide examples for loans and annuity contracts, including various examples of both. Program 235 may also provide a web front end, and be linked to back end computer systems for implementing administration of annuities and loan repayment, as well as to back end systems for other insurance company-administered products and services. Program 235 may, by way of example, provide a user with options to update contact information and payment information, such as bank account and routing number for electronic payments, and be configured to receive a signal from user device 205, 206, 207 inputting such information, and to communicate such information to a back end system, such as system 100, so as to permit user selection of a payment information. If a user has selected a variable annuity with investment options, a user may select investment options using program 235. Program 235 may be, by way of example only, a Java-based program.

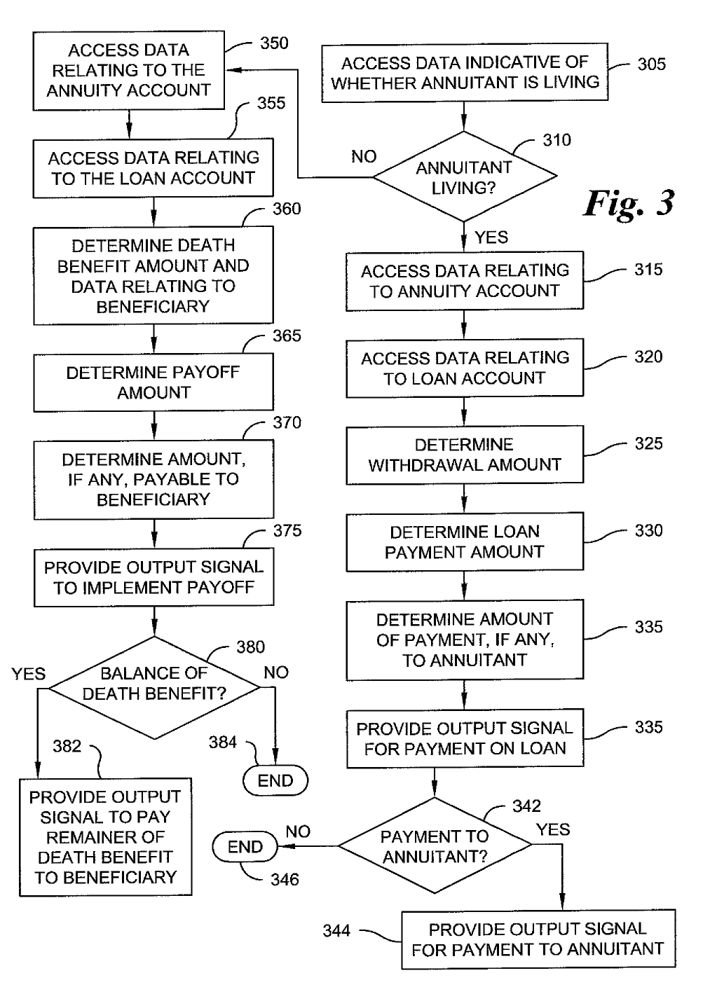

Referring now to FIG. 3, a high level process flow of a method for administering an insurance policy will be explained, with reference to the computer system of FIG. 1. In accordance with an implementation, an owner of an asset has entered into a loan agreement with a lender, and an insurance contract with an insurance company. Examples of insurance policies covered by such a contract include annuities, such as single premium immediate annuities, single premium deferred annuities, variable annuities, and variable annuities with riders such as lifetime guaranteed minimum withdrawal benefit riders, and riders providing lifetime guaranteed minimum withdrawal benefits to two people, such as both spouses of a couple who own the asset. Further non-limiting examples of insurance products include universal life policies, variable universal life policies, variable life policies and other types of life insurance policies having an account value and an option for payments to an insured, such as through partial surrenders. The repayment of the loan under the loan agreement is secured by a lien on, or security interest in, the asset. The lien or security interest may be perfected under applicable law. By way of example, security interests in many types of personal property may be perfected in the United States by filing pursuant to Article 9 of the version of the Uniform Commercial Code in force in the state of domicile of the borrower, in a state or county office. The asset may be an asset of a type that does not produce immediate income. A real estate asset used by the owner, such as a principal residence or a vacation home, is an example of such an asset. The real estate asset may be a principal residence of the insured and another person, such as the spouse of the insured, at the time of inception of the insurance policy and the loan. The insurance policy may provide for withdrawals to be paid to a designee of the insured. The designee may be the insured. The designee may be the insured until the real estate asset ceases to be the principal residence of the insured, and, if the real estate asset continues to be the principal residence of the another person, for withdrawals from the insurance policy to be paid to the another person for so long as the real estate asset continues to be the principal residence of the another person.

Other examples of assets include restricted stock or shares in privately-held corporations, limited liability companies or other entities, antiques and works of art, by way of example. If the asset is a real estate asset, the owner grants a mortgage to the lender to provide security for repayment. The lender, the customer and the insurance company may enter into one agreement or agreements with conditions under which the lender disburses the loan principal amount to the insurance company, which receives the principal amount as a premium payment on the annuity account. The payment to the insurance company may be net of any other payments associated with inception of the loan, such as costs of appraisals, title insurance and other closing costs. Of course, the borrower/insured may receive the disbursement from the lender and then pay the amount of the disbursement, net of any closing costs, to the insurance company as a premium. The borrower may pay the closing costs from other funds, and pay the entire principal amount of the loan to the insurance company as a premium.

In an implementation, a processor, such as processor 110 of FIG. 1, executes instructions contained in one or more executable program files stored in a computer readable medium. In accordance with the instructions, in an embodiment, the processor may access data indicative of whether the annuitant is living 305. If the annuitant is living 310, the process flow then proceeds to access 315 from the memory storage device data relating to the annuity account. In an alternative embodiment, the process flow may commence with accessing 315 from the memory storage device data relating to the annuity account. Data relating to the annuity account may include current contract value, guaranteed minimum withdrawal benefit amount data, which may be determined by a guaranteed minimum lifetime withdrawal benefit rider, formulas for determining payment dates or payment date information, account identifying alphanumeric data, annuitant identification data, other rider data, and other data. The processor then accesses 320 from the memory storage device data relating to the loan. The processor determines 325, based on the data relating to the annuity account, an amount of a withdrawal from the variable annuity account, and stores the amount of the withdrawal in a memory storage device, which may be a local memory. It will be understood that a withdrawal from an insurance account is formally termed a partial surrender. The term withdrawal as used herein with respect to insurance accounts includes partial surrenders. The amount of the withdrawal may be, for example, a predetermined amount. For example, if the insurance policy is a single premium immediate annuity, the withdrawal amount may always be the same amount. If the insurance policy is a variable annuity, the withdrawal amount may be calculated by taking a percentage of a benefit base. The benefit base may be, for example, the highest account value on an anniversary of a policy. The processor determines 330, based on the data relating to the loan, an amount of a payment on the loan, and stores the determined amount of the payment on the loan in a memory storage device, which may be a local memory. The processor determines 335, such as by deducting the amount of the payment on the loan from the amount of the withdrawal, an amount of a payment to the annuitant, if any. The processor stores the determined amount of the payment to the annuitant; if the determined amount of the payment is zero, then the determined amount may be stored, a flag may be set indicative that there is no payment to the annuitant, or another. The processor may determine this payment amount by accessing a previously calculated and stored payment amount from memory. The processor provides 340 an output signal to a payment system to implement the payment on the loan. If there is 342 a payment to the annuitant, the processor provides 344 an output signal to the payment system to implement the payment to the annuitant. If there is not a payment to the annuitant, then the process flow ends 346. In an embodiment in which the system does not determine whether the annuitant is living, then the process flow may end.

If the accessed data indicates that the annuitant is not living, and there is no other indication to continue withdrawals or annuity payments, e.g., to a secondary annuitant such as a spouse, then the processor accesses 350 from the memory storage device data relating to the annuity account. The processor accesses 355 from the memory storage device data relating to the loan. The processor determines 360, based on the data relating to the annuity account, death benefit amount and identification information relating to a beneficiary. The processor determines 365, based on the data relating to the loan, a payoff amount. A payoff amount may be determined according to a formula, such as principal balance of the loan after the last payment, plus the interest on the principal balance at the fixed interest rate of the loan for the period from the last prior payment to the anticipated date of the payoff payment. The processor determines 370, by deducting the payoff amount from the death benefit amount, an amount payable to the beneficiary, if any. The processor provides 375 an output signal to the payment system to implement a loan payment in the amount of the payoff amount. If there is 380 a balance of the death benefit after payment of the loan payoff amount, then the processor provides 382 an output signal to the payment system to implement a payment to the beneficiary in the amount payable to the beneficiary. If there is no balance of the death benefit after payment of the loan payoff amount, then the process ends 384.

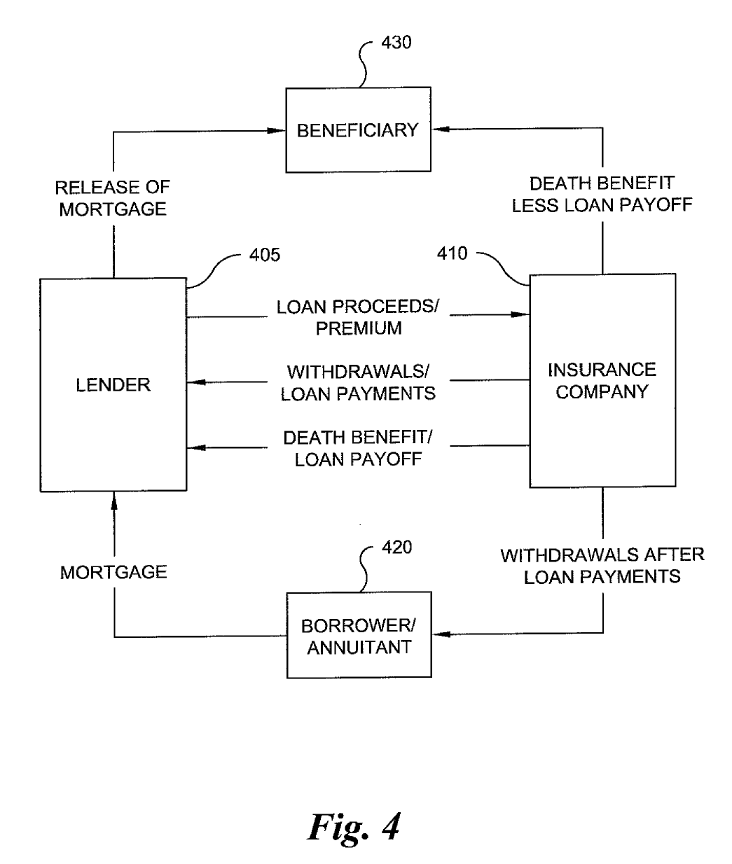

Referring now to FIG. 4, there is shown a schematic representation of a loan and insurance contract. Lender 405 enters into a secured loan agreement with a borrower 420 who is also an insured. In an embodiment, borrower 420 may be an annuitant. Borrower/insured 420 grants to lender 405 a mortgage on the property that secures repayment of the loan. Lender 405 disburses loan proceeds that are provided to insurance company 410 as a premium on the insurance contract. Insurance company 410 provides withdrawals from the insurance policy, or annuity payments in an embodiment in which the insurance contract is a single premium immediate annuity, up to the amount of the loan payments to lender 405. In an embodiment, a creditor other than the lender may be the recipient of the payment, such as if the loan is sold. In an embodiment, an agent of the creditor may be the recipient of the payment. If there is a balance of the withdrawals or payment after the payment to the lender, then the balance may be paid to the insured, or paid to the insured's designee. If the annuitant dies during the term of the loan and the insurance policy, if there is a death benefit associated with the insurance policy, a portion of the death benefit sufficient to pay off the loan principal balance, and any interest accrued subsequent to the last payment, is paid to the lender. In an embodiment, the death benefit is equal to the amount required to pay off the loan. The remainder of the death benefit is paid to the beneficiary 430. The lender releases the mortgage, thereby reconveying clear title. The mortgage is ordinarily released to the estate of the borrower. As the beneficiary is also ordinarily the heir or devisee of the property, the mortgage is shown as being released to the borrower.

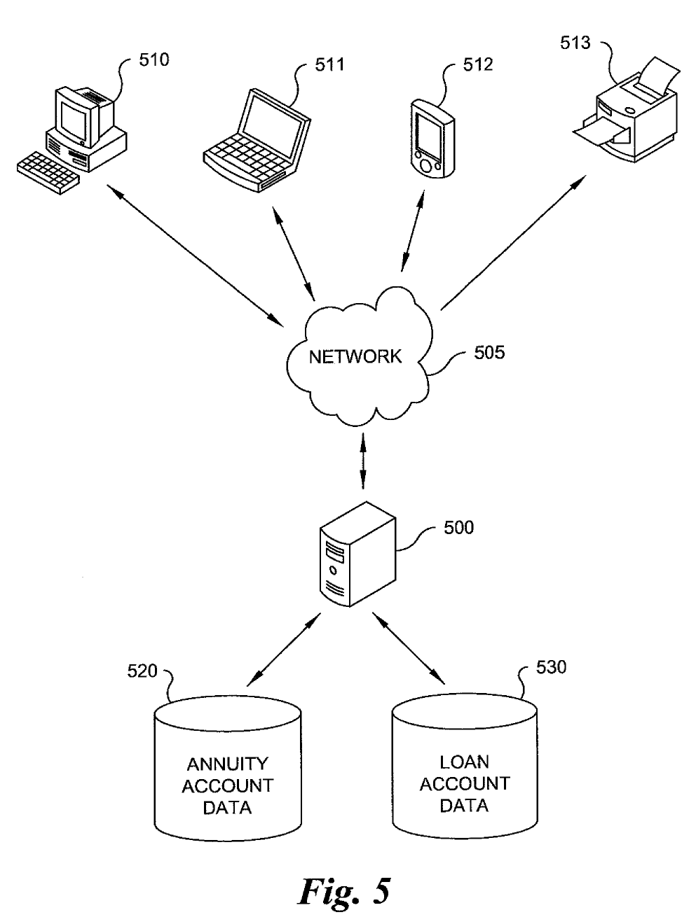

FIG. 5 illustrates an implementation in which a server, such as a web server 500, is adapted for providing current data as to either or both of annuity data and loan data in response to a user request to a client device. Users running suitable client programs, such as web server programs, on devices such as desktop computer system 510, laptop computer system 511 and personal digital assistant (PDA) 512, may communicate with server 500 via network 505, which may include one or more of the Internet, local area networks, wireless networks, wireless telephone networks and wired telephone networks (include copper and fiber, by way of example). Devices 510, 511, 512 may request, by providing suitable credentials to server 500, access to account data for a particular individual who is both a borrower and an annuitant, as described above. Once server 500 has confirmed the credentials (which may include, by way of non-limiting example, a user identification or user name issued only to the particular borrower/annuitant), and password, server 500 accesses data from annuity account data storage 520 and loan data storage 530. Server 500 may have tables associating a user identification with an account identification on annuity account data storage 520 and loan data storage 530. Server 500 then formats the data and serves documents incorporating the requested data to devices 510, 511, 512, and, in response to an appropriate request, may direct a document to printer 513 for printing. It will be appreciated that only a single log in is required for access to annuity account data and loan data.

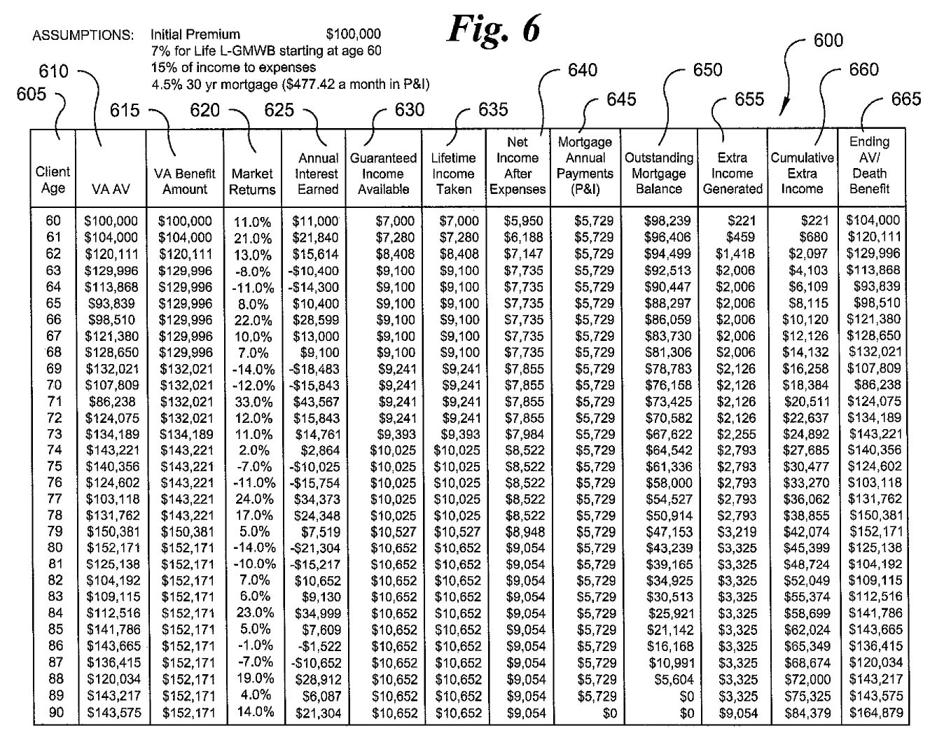

Referring now to FIG. 6, a chart 600 illustrates an example of a method and system according to an embodiment of the invention. In the example of FIG. 6, an owner of real property has borrowed $100,000, under a loan agreement with a fixed 4.5% interest rate for a 30 year term, with level amortization, resulting in a monthly payment of principal and interest of $477.42 per month. The payments represent a fully-amortized stream of payments for a period of years. The repayment obligation is secured by a mortgage on the property. The borrower has also obtained a variable annuity with an initial contract value of $100,000. The contract value is generally the sum of the net asset values of any subaccounts. The variable annuity has in this example is completely invested in a fund that tracks an equity index, such as the Standard & Poor's 500 index, such that the net asset value is equal to the contract value. The variable annuity has guaranteed annual withdrawal benefit rider for the lifetime of the borrower, in an amount of 7% of the account asset value, with no decline in the benefit amount. The resulting stream of payments from the annuity is for a sufficient time and in a sufficient amount to fund the fully-amortized stream of payments on the loan, provided that the annuitant is living. Thus, the guaranteed minimum withdrawal rider provides for an annual withdrawal greater than an annual amount of the loan payments according to the amortization schedule of the loan.

The death benefit under the annuity is the asset value of the annuity account. The borrower's age is 60 at the beginning of the transactions. Expenses, such as expenses necessary to comply with applicable state or Federal law, and chargeable against the withdrawals, are assumed to be 15%. For purposes of simplicity of illustration, closing costs on the loan and any initial fees on the annuity are not included in the illustration. The market returns are net of fees, such as costs of insurance, management fees, and rider fees.

The age of the borrower is indicated in age column 605. The asset value of the variable annuity account at the beginning of each year is indicated in asset value column 610. The asset value is calculated by adding or subtracting the market return for the prior year to the prior year's asset value, and then subtracting the lifetime income taken for that year. The base for calculation of the guaranteed minimum withdrawal benefit of the variable annuity is indicated in benefit base column 615. The base is the highest asset value at the beginning of the current year or any prior year under annuity. The market returns shown in the market returns column 620 are arbitrary sample market returns. The annual interest earned shown in interest earned column 625 is the product of the market returns and the asset value of asset value column 610. The guaranteed income available, as indicated in income available column 630, is calculated as a percentage, in this example 7%, of the base for calculation of the guaranteed minimum withdrawal benefit. The withdrawal amount is indicated in lifetime income taken column 635, and is equal to the amount available in this example.

The income after expenses available to the borrower is the withdrawal amount less the expense percentage, and is indicated in net income column 640. The mortgage payments for the year are indicated in the mortgage annual payments (P&I) column 645. It will be appreciated that the borrower's payments may include amounts escrowed for real estate taxes or homeowner's insurance payments, for example, but of course these are not relevant to the illustration. The outstanding principal balance on the loan at the end of the year after application of that year's payments to the principal amount is shown in outstanding mortgage balance column 650. The cash available to the borrower from the annuity after payment of expenses associated with the withdrawal and payment of the principal and interest on the loan is indicated in extra income generated column 655. The additional cash available in this example increases year to year from age 60 to age 63, as the returns exceed the withdrawals, thereby resulting in a net asset value increase. Thereafter, as the guaranteed withdrawal amount under the annuity contract cannot decrease, the additional cash available remains level for several years, until a further series of positive market returns results in an increase in net asset value over the previous high value. The guaranteed annual withdrawal has been selected so that the cash available after expenses associated with the withdrawal always exceed the principal and interest due on the loan. As the loan is fully paid at the end of year in which the borrower is 89, the additional income increases sharply at age 90. The total additional cash available over the period is shown in cumulative extra income column 660. As can be seen, over $84,000 in additional cash is made available from a loan having a principal amount of $100,000 over the 30 year period. The ending asset value, which is also the death benefit of the annuity, is shown in ending AV/death benefit column 665. In this example, as the market returns are strongly positive in the first three years of the annuity, the death benefit is always greater than the outstanding loan balance. In this example, the beneficiaries of the borrower would receive the property free of a mortgage, plus a balance of the death benefit.

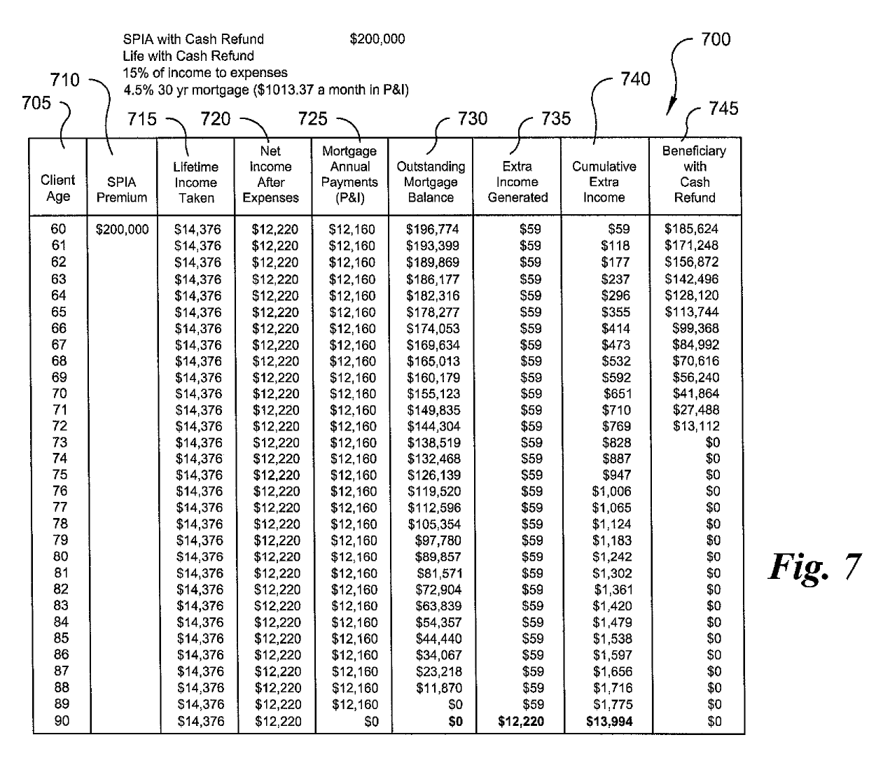

Referring now to FIG. 7, a chart 700 illustrates another example of a method and system according to an embodiment of the invention. In the example of FIG. 7, an owner of real property has borrowed $200,000, under a loan agreement with a fixed 4.5% interest rate for a 30 year term, with level amortization, resulting in a monthly payment of principal and interest of $1013.37 per month. The repayment obligation is secured by a mortgage on the property. The borrower has also contracted with an insurance company for a single premium immediate annuity (SPIA) with a single premium of $200,000. The SPIA pays the borrower each year during the borrower's lifetime an amount of $14,376. The death benefit under the annuity is the premium paid less the cumulative annuity payments to date. The borrower's age is 60 at the beginning of the transactions. Expenses chargeable against the withdrawals are assumed to be 15% of the amount withdrawn. For purposes of simplicity of illustration, closing costs on the loan and any initial fees on the annuity are not included in the illustration.

The age of the borrower is indicated in age column 705. The premium, which is a single premium, is shown in SPIA premium column 710. The amount of annuity payments to the borrower for the year is shown in lifetime income taken column 715. The net of the annuity payment to the borrower after payment of expenses is shown in income column 720. The annual net income is shown rounded to $12,220, although the actual amount is $12,219.60. The principal and interest payments on the loan for the year are shown in mortgage annual payments (P&I) column 725. That amount is shown rounded to $12,160, although the actual amount is $12160.44. The outstanding principal balance on the loan is shown in the outstanding mortgage balance column 730. The net of the annuity payment and principal and interest payment on the loan is shown in extra income generated column 735. The amount is shown rounded to $59, although the actual amount is $59.16. The cumulative net of the annuity payment and principal and interest payments on the loan is shown in cumulative extra income column 740. As may be seen, the cumulative extra income amount is rounded to the nearest dollar. The death benefit amount is shown in the beneficiary with cash refund column 745.

In an implementation, an insurance policy may have provisions permitting an insured or the insured's designee to effect changes to the withdrawal amounts or withdrawal formula during the policy term. For example, a policy may have an annual minimum withdrawal guarantee, which may be, by way of example, a rider in a variable annuity. The insured may select a withdrawal amount less than the guaranteed annual minimum withdrawal amount. The withdrawal amount for a period may be calculated by a system to be equal to the loan payments for the period, plus a percentage estimated to be sufficient to cover expenses associated with the withdrawal. For example, a system may provide a web based tool for such calculation, and may receive the selected withdrawal amount via the web based tool. For example, if the insured has other sources of income, such as income from continued employment, the insured may wish to minimize withdrawals so as to maximize accumulation of contract value. The insured may wish to avoid using any other sources of income to make payments on the loan.

In an embodiment, a processor of a system may receive at a first time, such as the issue date of the policy, an insured selection of a first annual withdrawal amount less than the guaranteed annual minimum withdrawal applicable at the first time, the first annual withdrawal amount being at least equal to the amount of annual payments on the loan. The processor may store the first annual withdrawal amount. When the processor determines the amount of the withdrawal from the insurance policy, such as on a policy anniversary, the processor may do so by accessing the stored first annual withdrawal amount.

At a later time, an insured may wish to increase the amount of the withdrawals. The insured may wish to increase the amount of the withdrawals to an amount equal to the guaranteed annual minimum withdrawal then applicable, or to an amount less than the guaranteed annual minimum withdrawal. The increased amount may be determined by an annual or other periodic amount provided by the insured to a system, such as via a web interface. The increased amount may be determined by a formula selected by the insured and provided to the system, such as via a web interface.

In an embodiment, a system processor may receive at a second time, after the first time, an insured selection of withdrawing an amount equal to the guaranteed annual minimum withdrawal applicable at the second time. The processor may determine the amount of the withdrawal from the insurance policy by determining a guaranteed annual minimum withdrawal percentage; determining a benefit base; and calculating, based on the guaranteed annual minimum withdrawal percentage and the benefit base, the amount of the withdrawal. In an embodiment, the determining of the benefit base may include determining a highest contract value of the insurance policy on an anniversary of the insurance policy.

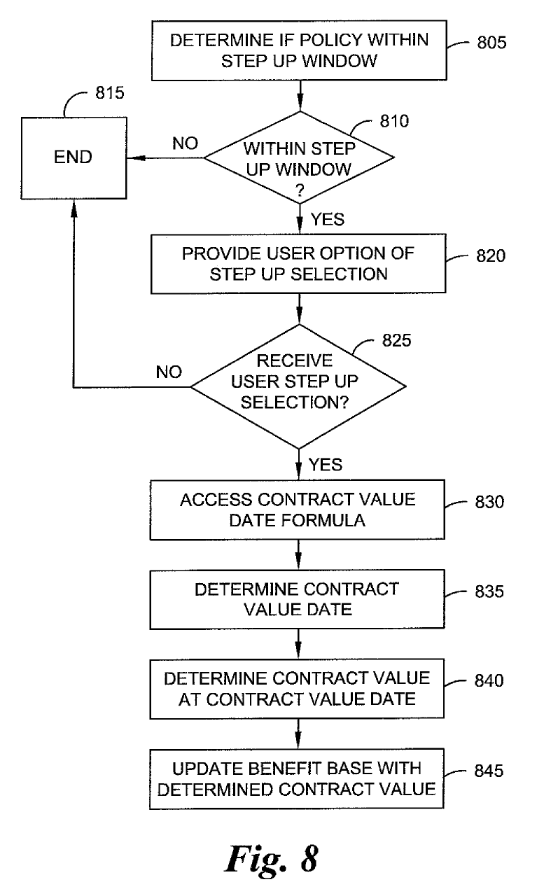

In an embodiment, the insurance policy may have a guaranteed annual minimum withdrawal benefit, which is calculated based on a benefit base. For example, the guaranteed annual minimum withdrawal benefit may be a percentage, such as from 4 percent to about 7 percent, of a benefit base. The insurance policy may have a step up option for the insured to increase the benefit base in at least one step up window. The window may be, for example, a period commencing a certain time period after the policy issue date. For example, the window may be any time after a particular policy anniversary, such as the first, second, third, or fourth. The window may expire after a time. For example, the window may commence on a first policy anniversary and expire one month or two months thereafter. Referring to FIG. 8, in a system, the processor may be adapted to determine 805 if the current date is within the step up window, or, if there is more than one step up window, such as the one month period after each policy anniversary, within one of the step up windows. If the current date is 810 within one of the at least one step up windows, the system may prompt 820 the user to select a step up option. For example, a system processor may be adapted to cause a web interface, upon login by the insured during one of the step up windows, to display a prompt for the user to select a step up option. If the current date is not within a step up window, the process may end 815.

If the user selects a step up option, the processor receives 825, 830 a signal indicative of the selection. The processor may access 830 a formula for a contract value date. The formula may be, for example, the most recent contract anniversary, or the contract anniversary having a highest contract value. The processor may determine 835 a contract value date from the formula. The processor may then determine 840 the contract value at the contract value date. The processor may update 845 the benefit base, as stored in a memory device, with the determined contract value.

When a system processor determines a withdrawal amount, the processor may determine the withdrawal amount by accessing a benefit base amount and a percentage, both stored in a memory device, and calculating the withdrawal amount as the percentage of the benefit base. The base may be an initial contract value, a contract value on a most recent anniversary, an anniversary date having a highest contract value, or another number.

When system processor receives a signal or otherwise receives data indicative of a death of an insured, or a death of another person, such as a surviving spouse of an insured, the system processor may be adapted to take certain actions. In an embodiment, in response to receiving a signal indicative of the death of the insured, the processor may be adapted to determine a death benefit amount by accessing a contract value and determining the contract value to be the death benefit amount. For example, if the insurance policy is a variable annuity, the death benefit may be the contract value. In an embodiment, in response to receiving a signal indicative of the death of the insured, the processor is adapted to determine a death benefit amount by determining a highest contract value on one or more selected dates. The selected dates may be policy anniversary dates. If the insurance policy is a variable annuity, the death benefit may be the highest contract value on a policy anniversary date. The processor may access data indicative of a loan amount, a creditor identity, and a beneficiary, and provide output signals to a payment system to provide payment to the creditor in the amount of the loan, up to the amount of the death benefit, and, if there is a balance of the death benefit, to the beneficiary.

In an embodiment, in response to receiving a signal indicative of the death of the insured, the processor may be adapted to determine the death benefit amount by calculating the premium less the cumulative withdrawals. If the insurance policy is an annuity, the death benefit amount may be equal to the premium less the cumulative withdrawals.

When a system processor receives a signal or otherwise receives data indicative of request for a complete surrender, the system processor may be adapted to take certain actions. An insured or another, may opt for a complete surrender upon deciding to sell the asset that secures the loan. For example, if the insured decides to move from the home, either to move to another home or to a nursing home or other care facility, the insured may opt for a complete surrender of the insurance policy. A system processor may be adapted to, in response to receiving a signal indicative of a request for a complete surrender of the insurance policy, determine a surrender value of the insurance policy based on a contract value at the time of the surrender less a surrender charge, if any, and to provide an output signal to the payment system to provide a payment to the insured in the amount of the surrender value. In an embodiment, the signal to the payment system may be to provide a payment to the creditor in an amount sufficient to pay off the loan, and to provide a payment to the insured in the amount of a balance, if any. A surrender charge may be applicable, for example, within a period of years of the policy issue date, and may be expressed as a percentage of the contract value. The surrender charge may decline stepwise with greater time after the policy issue date, and may be equal to zero a sufficient time after the policy issue date.

In an implementation, a property owner may consult with a financial advisor. The financial advisor may review the property owner's current retirement plans, anticipated lifestyle and expenses in retirement, anticipated gifts to family members, goals regarding value of the property owner's estate in the event of death at various times, and other factors. The financial advisor may conduct a needs based analysis including a review of the property owner's net worth, age, investment time horizons, current earned income and anticipated future earnings, financial acumen and risk tolerance. If the financial advisor recommends a loan secured by a mortgage on the property with the loan proceeds paid as an annuity premium, the property owner prepares, with the assistance of suitable representatives, applications for the loan and for the annuity. In an implementation, a single server may be maintained which collects application information, such as via web forms, and transmits the appropriate applications electronically to designated lenders and insurance companies. The applications may be simultaneously submitted to a lender, which may be a bank, credit union, savings and loan, or other lender, and an insurance company. The lender conducts its due diligence, and the insurance company may simultaneously perform its underwriting and qualification processes. Both the lender and the insurance company provide decisions to the owner or the owner's representative, such as a financial advisor. If the decisions are both positive, the lender may issue a commitment letter setting forth closing conditions. Upon closing of the loan, the lender issues a net proceeds remittance that is paid to the insurance company as a premium; the insurance company issues an annuity contract concurrently with receipt of the premium.

It will be appreciated that the fixed rate level amortization payment schedule is merely exemplary. For example, the loan secured by the mortgage may be an interest only loan with a repayment of the principal as a balloon payment at loan maturity. In this example, a variable annuity may be employed. Annuities and loans may be provided with variable interest rates based on matching formulas, to maintain a specified spread between the interest rate on the loan and the rate at which annuity benefits are paid. A borrower may purchase term life insurance or a death benefit rider to cover any gap between a death benefit and a principal amount of a mortgage. In an implementation, a payment under a SPIA may include a portion directed to payment of a term insurance premium. In an embodiment, the annuity has a guaranteed minimum withdrawal benefit rider for the lifetimes of the last to die of the annuitant and the secondary annuitant, such as a spouse. The guaranteed minimum withdrawal benefit rider may change to a reduced formula, such as 5% rather than 7%, upon the death of one of the annuitant and a spouse.

In an embodiment, a loan provides for deferral of a first payment and reverse amortization for a deferral period of at least one year, and the annuity account provides for deferral of a first annuity payment for the deferral period. The deferral period may be longer, such as 3, 5, 8 or 10 years. This embodiment may be advantageous for a variable annuity account, as the net asset value, and consequently the base for calculation of the guaranteed annual minimum withdrawal, as well as the death benefit, may increase during the deferral period, without deduction of withdrawal amounts. For example, in the illustration of FIG. 6, deferral of withdrawals through age 66 would result in an asset value of about $134,211, rather than an asset value of $98,510.

Wherever there is a reference to an annuitant or an annuity, the reference may be to an insurance policy and an insured. Where there is a reference to a payment to an annuitant or an insured, there may be a payment to another, such as a surviving spouse of an insured, who receives payments. Similarly, a selection of a step up or a complete surrender by an insured may, under some policies, be made by another person, such as a surviving spouse.

Embodiments of the present invention are operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of embodiments of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with an embodiment of the invention may include means corresponding to each step in each method described herein. Each means may be implemented by processor 110 executing instructions contained in programs which may be stored in a storage medium, such as local memory 120 or data storage 130. It will be appreciated that any of the steps in the methods in accordance with embodiments of the invention described herein may be so implemented.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for administering a variable annuity account, having a guaranteed minimum withdrawal rider, with an annuitant, the annuitant also being a mortgagor of a home mortgage, the mortgage securing a loan having a level amortization repayment schedule, comprising:
a processor;
a memory storage device in communication with the processor;
the processor adapted to:
access from the memory storage device data indicative of whether the annuitant is living, and, if the annuitant is living:
access from the memory storage device data relating to the variable annuity account;
access from the memory storage device data relating to the loan;
determine, based on the data relating to the variable annuity account, an amount of a withdrawal from the variable annuity account;
determine, based on the data relating to the loan, an amount of a payment on the loan, and store the determined amount of the payment on the loan;
determine, by deducting the amount of the payment on the loan to the amount of the withdrawal, an amount of a payment to the annuitant, and store the determined amount of the payment on the loan;
provide an output signal to a payment system to implement the payment on the loan;
provide an output signal to the payment system to implement the payment to the annuitant;
if the annuitant is not living:
access from the memory storage device data relating to the variable annuity account;
access from the memory storage device data relating to the loan;
determine, based on the data relating to the variable annuity account, a death benefit amount and beneficiary;
determine, based on the data relating to the loan, a payoff amount;
determine, by deducting the payoff amount from the death benefit amount, an amount payable to the beneficiary;
provide an output signal to the payment system to implement a loan payment in the amount of the payoff amount, and
provide an output signal to the payment system to implement a payment to the beneficiary in the amount payable to the beneficiary.

2. The system of claim 1, wherein a stored principal amount of the loan is equal to a single premium of the variable annuity account.

3. The system of claim 1, wherein the guaranteed minimum withdrawal rider provides for an annual withdrawal greater than or equal to an annual amount of payments on the loan according to an amortization schedule of the loan.

4. A computer system for administering an insurance policy, the insured under the policy also being a borrower on a loan secured by a lien on an asset, comprising:
a processor;
a memory storage device in communication with the processor;
the processor adapted to:
access from the memory storage device data relating to the insurance policy;
access from the memory storage device data relating to the loan;
determine, based on the data relating to the insurance policy, an amount of a withdrawal from the insurance policy, and store the amount of the withdrawal;
determine, based on the data relating to the loan, an amount of a payment on the loan, and store the determined amount of the payment on the loan;
determine, by deducting the amount of the payment on the loan from the amount of the withdrawal, an amount, if any, of a payment to a designee under the insurance policy, and store the determined amount of the payment on the loan;
provide an output signal to a payment system to implement the payment on the loan; and
if there is a payment to the insured, provide an output signal to the payment system to implement the payment to the designee.

5. The system of claim 4, further comprising, prior to said step of determining a withdrawal amount, determining whether the insured is living, and if the insured is not living:
access from the memory storage device data relating to the insurance policy;
access from the memory storage device data relating to the loan;
determine, based on the data relating to the insurance policy, a death benefit amount and beneficiary;
determine, based on the data relating to the loan, a payoff amount;
determine, by deducting the payoff amount from the death benefit amount, an amount, if any, payable to the beneficiary;
provide an output signal to the payment system to implement a loan payment in the amount of the payoff amount, and
if there is an amount payable to the beneficiary, provide an output signal to the payment system to implement a payment to the beneficiary in the amount payable to the beneficiary.

6. The system of claim 4, wherein a principal amount of the loan is equal to a single premium of the insurance policy.

7. The system of claim 4, wherein the insurance policy is a single premium immediate annuity.

8. The system of claim 5, wherein the loan has a fixed interest rate, the interest on the principal of the loan for a period being less than an amount of the withdrawal from the single premium immediate annuity for the period.

9. The system of claim 8, wherein the loan provides for a fully-amortized stream of payments for a period of years, a stream of payments from the annuity being for a sufficient time and sufficient amount to fund the fully-amortized stream of payments.

10. The system of claim 4, wherein the insurance policy is a variable annuity with a guaranteed annual minimum lifetime withdrawal benefit rider.

11. The system of claim 10, wherein the loan has a fixed interest rate, the interest on the principal of the loan for a period being less than an amount of the withdrawal under the guaranteed minimum lifetime withdrawal benefit rider for the period.

12. The system of claim 11, wherein the loan provides for a fully-amortized stream of payments for a period of years, a stream of payments as provided in the guaranteed minimum lifetime withdrawal benefit rider being for a sufficient time and sufficient amount to fund the fully-amortized stream of payments.

13. The system of claim 4, wherein the loan provides for deferral of a first payment and reverse amortization for a deferral period of at least one year, and the insurance policy provides for deferral of a first payment from the insurance policy for the deferral period.

14. The system of claim 4, further comprising a web server, the web server adapted to, in response to a request from a client device, access and serve for display on the client device data related to the insurance policy and the loan.

15. The system of claim 4, wherein the payment system comprises:
a payment determination system having a processor for: receiving one of the output signals, determining a payor account and a payment method; storing the determined payor account information and the determined payment method in a memory of the payment determination system; outputting of a digital signal indicative of the stored payor account information, the stored payment method, amount information and payee information; and
a payment fulfillment system for receiving the digital signal from the payment determination system and for fulfillment of payment in accordance with the information conveyed by the digital signal from the processor of the payment determination system.

16. The system of claim 15, wherein the payment fulfillment system is a check printing and mailing system for printing and mailing a check drawn on the payor account in an amount and to a payee as determined by the information conveyed by the digital signal from the processor of the payment determination system.

17. The system of claim 15, wherein the payment fulfillment system is a system for generating electronic funds transfer instructions for providing of an instruction to a bank determined by the payor account information to provide an electronic funds transfer from the payor account to a payee account in an amount determined by the information conveyed by the digital signal from the processor of the payment determination system.

18. The system of claim 4, wherein the asset is a principal residence of the insured and another person at an inception of the insurance policy, and the designee is: the insured until the asset ceases to be the principal residence of the insured, and thereafter the another person for such time, if any, after the asset ceases to be the principal residence of the insured, that the asset continues to be the principal residence of the another person.

19. The system of claim 4, wherein the insurance policy has a guaranteed annual minimum withdrawal, the processor being further adapted to:
receive at a first time an insured selection of a first annual withdrawal amount less than the guaranteed annual minimum withdrawal applicable at the first time, the first annual withdrawal amount being at least equal to the amount of annual payments on the loan;
store the first annual withdrawal amount, whereby the processor determines the amount of the withdrawal from the insurance policy by accessing the stored first annual withdrawal amount;
receive at a second time an insured selection of withdrawing an amount equal to the guaranteed annual minimum withdrawal applicable at the second time;
whereby the processor determines the amount of the withdrawal from the insurance policy by determining a guaranteed annual minimum withdrawal percentage; determining a benefit base; and calculating, based on the guaranteed annual minimum withdrawal percentage and the benefit base, the amount of the withdrawal.

20. The system of claim 19, wherein the determining of the benefit base includes determining a highest contract value of the insurance policy on an anniversary of the insurance policy.

21. The system of claim 4, wherein the insurance policy has a guaranteed annual minimum withdrawal benefit based on a benefit base and having a step up option for the insured to increase the benefit base in at least one step up window, wherein the processor is further adapted to:
determine if the current date is within one of the at least one step up windows;
if the current date is within one of the at least one step up windows, prompt the user to select a step up option;
if the user selects a step up option, access a formula for a contract value date;
determine a contract value date from the formula;
determine the contract value at the contract value date; and
update the benefit base with the determined contract value.

22. The system of claim 4, wherein the processor is further adapted to determine the withdrawal amount by accessing a benefit base amount and a percentage, and calculating the withdrawal amount as the percentage of the benefit base.

23. The system of claim 4, wherein, in response to receiving a signal indicative of the death of the insured, the processor is adapted to determine a death benefit amount by accessing a contract value and determining the contract value to be the death benefit amount.

24. The system of claim 4, wherein, in response to receiving a signal indicative of the death of the insured, the processor is adapted to determine a death benefit amount by determining a highest contract value on one or more selected dates.

25. The system of claim 4, wherein, in response to receiving a signal indicative of the death of the insured, the processor is adapted to determine the death benefit amount by calculating the premium less the cumulative withdrawals.

26. The system of claim 4, wherein the processor is adapted to, in response to receiving a signal indicative of a request for a complete surrender of the insurance policy, determine a surrender value of the insurance policy based on a contract value at the time of the surrender less a surrender charge, and to provide an output signal to the payment system to provide a payment to the insured in the amount of the surrender value.

27. A computer-implemented method for administering an insurance policy, the insured under the policy also being a borrower on a loan secured by a lien on an asset, comprising:
accessing by a processor from a memory storage device in communication with the processor data relating to the insurance policy;
accessing from the memory storage device data relating to the loan;
determining, based on the data relating to the insurance policy, an amount of a withdrawal from the insurance policy, and store the amount of the withdrawal;
determining, based on the data relating to the loan, an amount of a payment on the loan, and store the determined amount of the payment on the loan;
determining, by deducting the amount of the payment on the loan from the amount of the withdrawal, an amount, if any, of a payment to the insured, and store the determined amount of the payment on the loan and the determined amount, if any, of the payment to the insured;
providing an output signal to a payment system to implement the payment on the loan;
if there is a payment to the insured, providing an output signal to the payment system to implement the payment to the insured.

28. The method of claim 27, wherein the asset is a principal residence of the insured, the insured being a mortgagor of the principal residence.

29. The method of claim 28, wherein the loan has a fixed interest rate, and the insurance policy is a variable annuity having a guaranteed minimum lifetime withdrawal benefit rider, the interest on the principal of the loan for a period being less than an amount of the withdrawal under the guaranteed minimum lifetime withdrawal benefit rider for the period.

30. A computer-readable medium having a plurality of instructions thereon which, when executed by a processor, cause the processor to perform, in connection with administration of an insurance policy, the insured under the policy being a borrower on a loan secured by an asset:
access from a memory storage device coupled to the processor data relating to the insurance policy;
access from the memory storage device data relating to the loan;
determine, based on the data relating to the insurance policy, an amount of a withdrawal from the insurance policy;
determine, based on the data relating to the loan, an amount of a payment on the loan, and store the determined amount of the payment on the loan;
determine, by deducting the amount of the payment on the loan to the amount of the withdrawal, an amount, if any, of a payment to a designee under the policy, and store the determined amount of the payment on the loan;
provide an output signal to a payment system to implement the payment on the loan; and
if there is a payment to the designee, provide an output signal to the payment system to implement the payment to the designee.

31. The computer-readable medium of claim 30, wherein the asset is the principal residence of the insured and another person, and wherein the instructions further comprise instructions to determine whether the insured and the another person are living, and, if the insured is not living and the another person is living, provide the output signal to the payment system to implement the payment to the another person as designee.

32. The computer-readable medium of claim 31, wherein the insurance policy is an annuity having a guaranteed minimum withdrawal benefit rider for the lifetimes of the last to die of the insured and the another person.
